(19) United States
(12) Patent Application Publication
(10) Pub. No.: US 2013/0326338 A1
(43) Pub. Date: Dec. 5, 2013

(54) Methods and systems for organizing content using tags and for laying out images

(71) Applicants: Adrian Secord, New York, NY (US); Hendrik Kueck, Vancouver (CA)

(72) Inventors: Adrian Secord, New York, NY (US); Hendrik Kueck, Vancouver (CA)

(73) Assignee: Adobe Systems Incorporated

(21) Appl. No.: 11/899,685

(22) Filed: Sep. 7, 2007

(51) Int. Cl. G06F 17/00

(52) U.S. Cl. 715/243

(57) ABSTRACT

Methods and systems for placing images on a display such that images that are closely related to each other are placed near each other, and images that are unrelated are placed further away. The invention encompasses various techniques that may be used to determine how related or similar images are to one another, including methods that take into account user-supplied tags or other tags that describe the image's content and/or source. Color content, image content, time of image capture, and/or, other attributes may also be used in assessing image similarity. For example, one embodiment of the invention is a method for laying out images based on the similarity of the images with respect to color, tags, and/or other metadata. The layout of images may also involve removing overlap between images.

### FIELD OF THE INVENTION

The present invention relates to methods and systems for laying out images, including methods and systems for laying out images based on image similarities.

### BACKGROUND

Personal image collections have grown larger and more extensive over time. It is not uncommon for a collection to reach ten to twenty thousand images, often left unsorted or uncategorized in the digital version of a shoebox. The most common organization method used, if one is used at all, is to sort the images into a hierarchical set of categories, for example people→family→mom. In addition, image tagging is supported in one form or another by most photo management programs on the market today. Such tagging allows images to be associated with one or more tags that typically describe the image in some way. For example, an image of a dog in a park might be tagged with “dog,” “park,” and “Sparky,” if that is the dog's name, to describe the content of the image. Tags are a popular image metadata and are supported by many Adobe® products such as Lightroom®, Photoshop®, and others, and can take other forms aside from keywords.

Browsing though image collections becomes more difficult as the collection grows. Typically an application will provide a scrollable list of thumbnails and some method of filtering a collection. For example, the user might choose to view a specific folder of images or to search his/her collection for a particular keyword or tag. The results are nearly always displayed as a long scrollable list of thumbnails. Lists of thumbnails give little or no information about how the items are related to each other. Image collections are relatively rich in information such as image capture time, file name, location on the hard drive, camera parameters (exposure, etc.), color information and tags. Current methods of displaying lists of images do not take advantage of this extra information and fail to provide for the display of images in a way that shows the connections or similarities between images in an intuitive way.

### SUMMARY

Embodiments of the present invention provide methods and systems for dynamically placing images on a screen such that images that are closely related to each other are placed near each other, and images that are unrelated are placed further away. The invention encompasses various techniques that may be used to determine and/or quantify how related or similar images are to one another, including methods that take into account user-supplied tags or other tags that describe image content. Color content, image content, time of image capture, and/or other attributes may also be used in assessing image similarity. For example, one embodiment of the invention is a method for laying out images based at least in part on the similarity of the images with respect to color, tags, and/or other metadata.

One embodiment of the present invention is a method of laying out images. In this method, a collection of images stored on at least one computing device is identified with at least one tag associated with at least some of the images of the collection. The similarity of each image to every other image is determined using at least some of the tags associated with at least some of the images of the collection. A layout is determined using the similarity between at least some of the images, the location of at least some of the images in the layout based at least in part on the similarity of the image to at least one other image. The images are laid out or otherwise displayed or printed according to the determined layout.

One embodiment of the present invention comprises a method of laying out images that comprises identifying images, determining similarities, determining a layout, and laying out the images. This may comprise identifying a collection of images with at least one tag associated with at least some of the images of the collection. The method may comprise determining a similarity of each image of the collection to other images of the collection using at least some of the tags associated with at least some of the images of the collection. Determining similarity may involve comparing every image to one another, recognizing that two images are tagged with a same tag, and/or using the frequency tags are used together with images. The method may comprise determining a layout using the similarity between at least some of the images. The location of at least some images in the layout may be based at least in part on the similarity of the image to at least one other image. Images may be positioned in the layout and/or sized to avoid overlapping. And, the method may comprise laying out the images of the collection according to the layout.

One embodiment of the present invention comprises a method of laying out images that comprises identifying a collection of images, determining low-dimensional positions for the images based on image similarities, determining a layout using the low dimensional positions and laying out the images according to the layout. Determining low-dimensional positions for the images based on image similarities may comprise assessing a combination of similarities (for example relating to tag, time, or color similarity) and may comprise multidimensional scaling or any other suitable technique.

In other embodiments, a computer-readable medium (such as, for example random access memory or a computer disk) comprises code for carrying out these methods.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, embodiments, advantages of the present invention are better understood when the following Detailed Description is read with reference to the accompanying drawings, wherein:

FIG. 1 is a system diagram illustrating an illustrative network environment according to one embodiment of the present invention;

FIG. 2 is a flow chart illustrating one method of laying out a collection of images according to one embodiment of the present invention;

FIG. 3 is an exemplary image layout according to one embodiment of the present invention;

FIG. 4 is an exemplary image layout with gridded overlap according to one embodiment of the present invention;

FIG. 5 illustrates a layout without overlap between images produced according to one embodiment of the present invention;

FIG. 6 illustrates another layout without overlap between images produced according to one embodiment of the present invention; and

FIG. 7 illustrates another layout without overlap between images produced according to one embodiment of the present invention.

The file of this patent contains at least one drawing executed in color. Copies of this patent with color drawing(s) will be provided by the Patent and Trademark Office upon request and payment of the necessary fee.

### DETAILED DESCRIPTION

### Illustrative Image Layout

Embodiments of the present invention provide methods and systems for the layout of an image collection (such as a personal photograph collection) using the relationships amongst user-defined tags. In one illustrative embodiment, a user downloads a collection of images from a digital camera to a desktop computer where the images are stored as electronic files. The user then associates tags with several of the images. For example, the user tags a first image with “dog,” “cute,” and “park,” a second image with “birds” and “park,” a third image with “vacation,” “beach,” and “dog,” a fourth image with “baby” and “cute,” a fifth tag with “baby” and “eating,” and other images with various tags assigned or otherwise associated.

The user executes an image organizing application. For example, the user may launch a file organizing application that displays icons (for example small versions of the images themselves) for the files in a specified folder. However, the application need not be part of a file management system. In any case, the application identifies the collection of images and displays a layout of the images. In determining where to layout the images the application takes into account the tags of the images. In the present example, the application recognizes that the first image and second image are both tagged with a “park” tag, that the first image and third image are both tagged with a “dog” tag, and that the first image and fourth image are both tagged with a “cute” tag. The layout determined for the images reflects these similarities between images by placing or otherwise positioning images sharing the same tags near one another.

The application may also recognize relationships between tags within the collection or elsewhere. In the present example, the application may recognize that at least one image is tagged with both “baby” and “cute.” The application may survey the entire collection (and/or other collections or other sources) to determine how frequently “baby” and “cute” appear together as one way of determining whether those word tags are correlated. For example, a numerical value may be assigned or determined to represent the correlation between the usage of tags. As a simple example, in a collection of 1000 images, the tags “baby” and “cute” may tag the same image 20 times while the tags “baby” and “eating” may tag the same image only 8 times. Those occurrence values (e.g., 20 and 8) and/or other values that represent the correlation amongst tags may be used to determine the layout of tiles. In the present example, the application recognizes that the first image and the fifth image have some similarity even though they do not have any tags in common by recognizing that the fifth image's “dog” tag is correlated with the “cute” tag and thus that the fifth image has some similarity to images tagged with “cute” such as the first image.

The layout application may also account for non-tag-based similarities amongst the images of a collection when determining the layout. For example, the application may analyze the actual content of the images and recognize common colors, common faces, common words, and/or any other suitable common attributes. The application may also recognize other types of similarities amongst the images. For example, the application may examine metadata about the images such as date of image capture, date of download, etc.

Each category or dimension of potential similarity (as examples, sharing a given tag, sharing a given tag association, sharing a color, sharing a image-capture date, etc.) can be used to determine a layout. The application may use such similarities in any suitable way to determine an appropriate layout including in ways that account for user preferences and actions. The application may, for example, determine a combination of similarities (for example, one for each category/dimension associated with a given potential image similarity). The similarities represented may be converted to two dimensional space as part of the determination of positions for the images of the layout. For example, multidimensional scaling or any other suitable technique may be used to compute low-dimensional layout positions for the images. Once the application has determined low-dimensional layout positions for the images, for example in two dimensional space, the image positions and the size of the images are adjusted so that the images to be displayed in the layout will not overlap.

This illustrative example is given to introduce the reader to the general subject matter discussed herein. The invention is not limited to this example. The following sections describe various additional embodiments and examples of methods and systems for laying out images.

### Illustrative Computing Environment

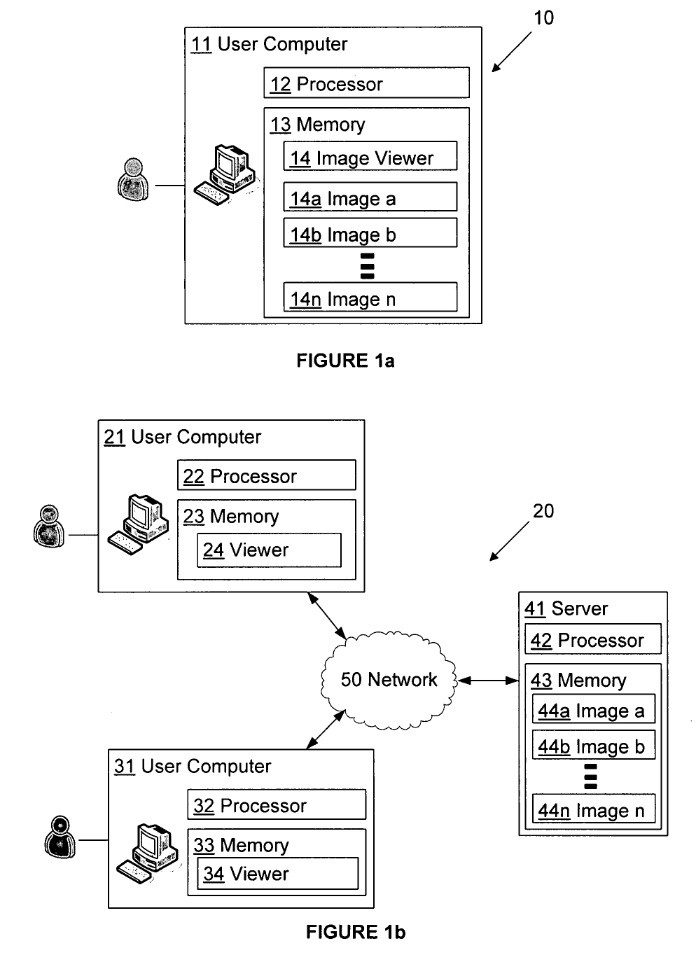

FIGS. 1a-1b are system diagrams illustrating image use and management environments according to several embodiments of the present invention. Other embodiments may be utilized. The system 10 shown in FIG. 1a comprises a user computer 11 that comprises a computer-readable medium such as a random access memory (RAM) 13, coupled to a processor 12 that executes computer-executable program instructions stored in memory. Such a processor 12 may comprise a microprocessor, an ASIC, a state machine, or other processor, and can be any of a number of computer processors, such as processors from Intel Corporation of Santa Clara, Calif. and Motorola Corporation of Schaumburg, Ill. Such processor a comprise, or may be in communication with, media, for example computer-readable media, which stores instructions that, when executed by the processor, cause the processor to perform the steps described herein. An alternative system 20 shown in FIG. 1b comprises a wired or wireless network 50 connecting user computers 21, 31 and a server 41. The devices 21, 31, 41 each may comprise a computer-readable medium such as a random access memory (RAM) 23, 33, 43, coupled to a processor 22, 32, 42 that executes computer-executable program instructions stored in memory.

Embodiments of computer-readable media comprise, but are not limited to, an electronic, optical, magnetic, or other storage or transmission device capable of providing a processor with computer-readable instructions. Other examples of suitable media comprise, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, JavaScript, and ActionScript.

In FIG. 1a, the user computer 11 comprises an image viewer application 14 that may reside in memory 13. The image viewer application 14, for example, may be an application that allows a user to organize, store, import, export, delete, tag, create, and/or view one or more images, among other functions. The images themselves are typically graphical representations displayed on a computer screen of an image file 14a-n. An image viewing application may be a dedicated application designed to help a user manage and view images, may be a file management application that allows a user to organize files and then launch or otherwise display the contents of the file, whether in that application or through another application. An image viewing application may display icons that are based or derived from the image content of an image file. For example, an image viewing application may be a file organizing application that displays image files as icons of the images themselves.

As illustrated in FIG. 1b, methods according to the present invention need not operate within a single device. For example, as illustrated in FIG. 1b, users operating separate devices 21, 31 may view or receive images 44a-n stored on a separate device 31. A network 50, which may be any suitable private network, public network, or the Internet, may be employed to facilitate the sharing of images and to allow different users and different locations to access, manage, view, tag, or otherwise use a collection of images, such as images 44a-44n.

Generally, the devices 11, 21, 31, 41 of FIGS. 1a-1b may also comprise a number of external or internal devices such as a mouse, a CD-ROM, DVD, a keyboard, a display, or other input or output devices. Examples of such devices are personal computers, digital assistants, personal digital assistants, cellular phones, mobile phones, smart phones, pagers, digital tablets, laptop computers, Internet appliances, and other processor-based devices. In general, a device may involve any type of processor-based platform that operates on any operating system, such as Microsoft® Windows® or Linux, capable of supporting one or more client application programs. Other applications can be contained in memory 13, 23, 33, 43 and can comprise, for example, a word processing application, a spreadsheet application, an e-mail application, a media player application, an instant messenger application, a presentation application, an Internet browser application, a calendar/organizer application, and any suitable application or computer program. Other configurations may also involve server devices, mainframe computers, networked computers, and other system configurations appropriate for the particular context.

Certain embodiments of the present invention relate to systems used for image management and viewing on a computing device. It will be recognized that this is merely one context for the methods and other features of the invention described herein. For example, certain embodiments will involve management on a digital camera or video recorder and certain embodiments will involve other type of content, such as video, audio, animation, text documents, word processing documents, e-mail, general files of any type, and any suitable category of documents. For example, various techniques of the invention for organizing files using tags are applicable in the image file context and in the more general context of any file or other object that can be tagged and organized using, at least in part, the tag. The techniques for organizing and displaying content and the other features described herein have uses in a variety of contexts, not to be limited by the specific illustrations provided herein. The systems shown in FIGS. 1a-1b and methods described herein are merely illustrative and are not intended to recite any system component or feature as essential or necessary to any embodiment of the invention.

### Illustrative Embodiment of Laying Out Images

One embodiment of the present invention involves a combination of using tags to determine how similar images are and using those determined similarities to derive the two dimensional layout of images.

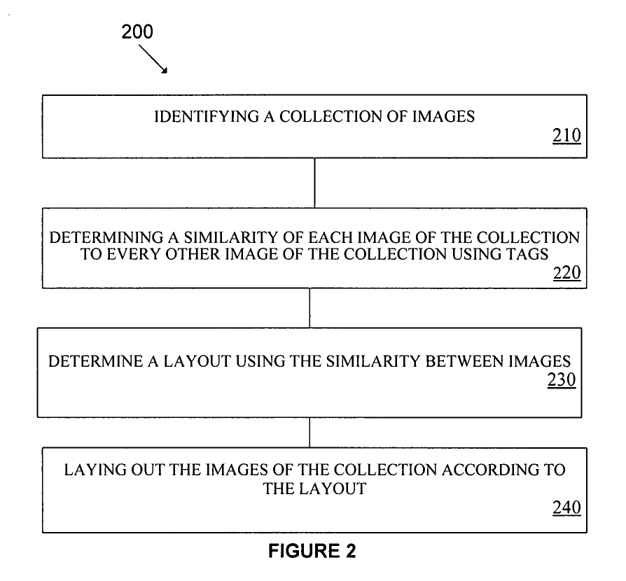

FIG. 2 is a flow chart illustrating one method of laying out a collection of images according to one embodiment of the present invention. For purposes of illustration only, the elements of this method are described with reference to the system depicted in FIGS. 1a and 1b. A variety of other implementations are also possible.

In the method 200 of laying out images shown in FIG. 2, an image viewer application 14 identifies a collection of images, as shown in block 210. The collection of images may have been identified by the user, for example by the user manually selecting individual documents to be included in the collection, by the user selecting a folder or collection, by the user launching an application, or in any other way. The user need not be involved in the identification of images since the viewing application may make the identification with or without user interaction.

There may be one or more tags associated with some or all of the images of the collection. Tags may have been automatically generated, provided by the user, or associated with an image in any other suitable manner. For example, if the identified collection is a collection of photographs, over time a user may have added or associated tags with the photographs. The user may have tagged various photographs with keywords, numbers, or other tags to, for example, describe each photo's content and/or source. As a specific example, a user may have gone through a photo collection and labeled all pictures of his dog with a “dog” tag and a tag for the name of the dog—a “Fido” tag.

In the method 200 of laying out images shown in FIG. 2, the image viewer application 14 determines a similarity of each image of the collection to other images of the collection, as shown in block 220. These determinations use at least some of the tags associated with at least some of the images of the collection. For example, a determination may involve assessing whether images share tags. Such a determination may examine two images, one tagged “dog” and “Fido” and the other tagged “dog” and “cat” and determine that the images are related because they are both associated with the “dog” tag as compared with another image with which neither image shares a tag, such as one tagged only with “water bottle.”

Similarity may also be based on whether images use tags that are related to one another even if not identical, such as an image with a “dog” tag and an image with a “pet” tag. Such relatedness amongst tags may be known from the usage of tags together for a given image—tag co-occurrence. Tag relatedness may also be known or partially based on a database, thesaurus, and/or and other source. Generally, the similarity amongst tags may be used to infer similarity amongst images that use those tags. Whether based on shared tags, tag similarity, or otherwise, the image similarity may, but need not, be a semantic distance measure that quantifies the similarity amongst the images of a collection. Such distances may be used to create a matrix or table holding the relationships between every given pair of images in the collection.

In the method 200 of laying out images shown in FIG. 2, the image viewer application 14 determines a layout using the similarity between at least some of the images, as shown in block 230. The location of at least some images in the layout may be based at least in part on the similarity of the image to at least one other image. The layout will generally be either one, two, or three dimensional. Determining a layout may, but need not, utilize multi-dimensional scaling, for example to account for the similarity amongst tags and then use that to determine an appropriate layout. Multi-dimensional scaling (MDS) may be used on quantified similarities amongst the images of a collection, such as the values of the distance matrix describe above. These values represent semantic distance measures between any two images and thus provide parallel comparisons that need to be combined into one low dimensional space. MDS may thus be used to convert or scale many parallel comparisons to layout on a single one, two, or three low dimensional space.

As a specific example of using MDS to determine a layout, a set of 100×100 distances between the hundred images in a collection could be inputted to a MDS routine. The MDS then performs a numerical optimization to find a set of points (for example, in a two dimensional space) to assign to the images such that the distances are preserved as best as they can be. The set of points produced by an MDS may be scaled or otherwise adjusted to determine an image layout of an appropriate size for the circumstances, for example to fit the computer application window in which the images will be displayed. Additionally, the layout may be generated or adjusted to remove or minimize overlap between images.

MDS may account for other things in addition to tag similarity. For example, MDS may also account for image color, metadata, GPS coordinates, camera settings, and other non-tagged attributes that can be relate or compared amongst images. For example, date of creation may be used and weighted above tag similarity or color.

In the method 200 of laying out images shown in FIG. 2, the image viewer application 14 lays out the images of the collection according to the layout determined, as shown in block 230. For example, the images may be laid out within a window on the user's computer screen. As another example, the images may be printed on a printing device.

### Tag Co-Occurrence Determination

An exemplary co-occurrence matrix C may be constructed by counting the pair-wise co-occurrences of tags in a set. The entry C_{i,j} contains the number of times the tags wᵢ and wⱼ appear together as annotations for the same image. A similarity measure for the bag of words model in statistical text processing is the cosine of the angle between the word count vectors:

$$s ( {b}_{i} , {b}_{j} ) = \frac{〈 {b}_{i} , {b}_{j} 〉}{\sqrt{〈 {b}_{i} , {b}_{i} 〉 〈 {b}_{j} , {b}_{j} 〉}}$$

Applied to tagged images, this measure corresponds to the count of shared tags between two images, normalized by the number of tags in each image. By introducing the tag co-occurrence matrix C as a kernel matrix into the dot product, a simple similarity measure can be derived that takes the co-occurrence statistics of tags into account.

$${s}_{sem} ( {b}_{i} , {b}_{j} ) = \frac{{b}_{i} {Cb}_{j}}{\sqrt{{b}_{i} {Cb}_{i}} \sqrt{{b}_{j} {Cb}_{j}}}$$

Using this kernel, the similarity of different but commonly co-occurring tags is high, while it would be 0 under the standard cosine measure. One improvement to this model is to take indirect co-occurrences into account. That is, to treat two tags as somewhat more similar if both of them commonly co-occur with a third tag. This is particularly helpful to semantically relate new tags introduced by the user to other pre-existing tags. For example if the user introduces the new tag “Spike” and uses it together with the “dog” tag, “Spike” will then be known to be somewhat similar to all things dog-related. This can be achieved by replacing the co-occurrence matrix C in the above equation with:

$$\tilde{C} = {D}^{- \frac{1}{2}} {CD}^{- \frac{1}{2}} + {λ ( {D}^{- \frac{1}{2}} {CD}^{- \frac{1}{2}} )}^{2}$$

where D is a diagonal matrix containing the row sums of C and λ is a parameter controlling the trade off between the direct and indirect influences of tag co-occurrences. The normalization using D allows it to choose λ independently of the magnitude of the co-occurrence counts.

### Illustrative Embodiments of Image Overlap Removal and Image Scaling

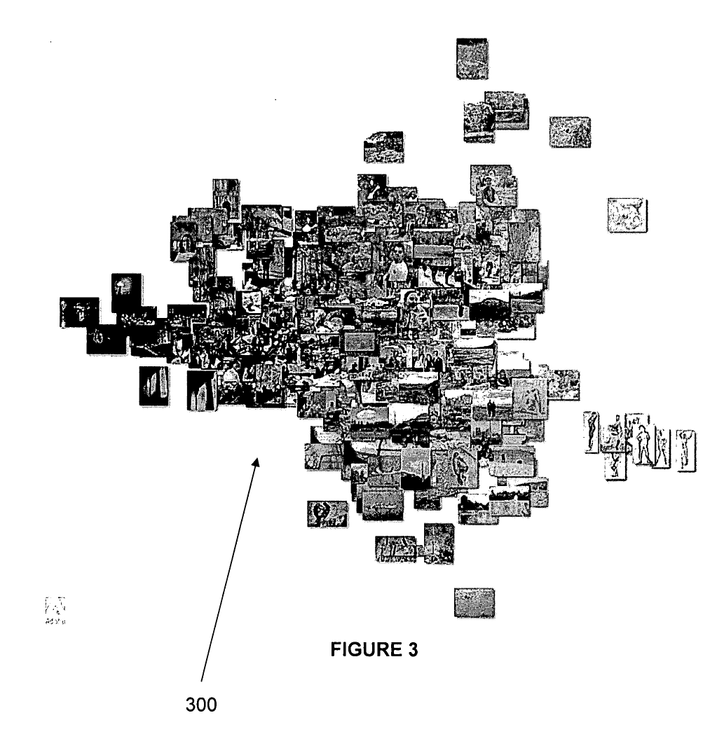

FIG. 3 is an exemplary image layout 300 according to one embodiment of the present invention. In the example of the preceding section, an MDS may return locations for images in which images overlap such as in layout 300. Because the MDS essentially is returning a single x-y point, images may overlap even though differences exist.

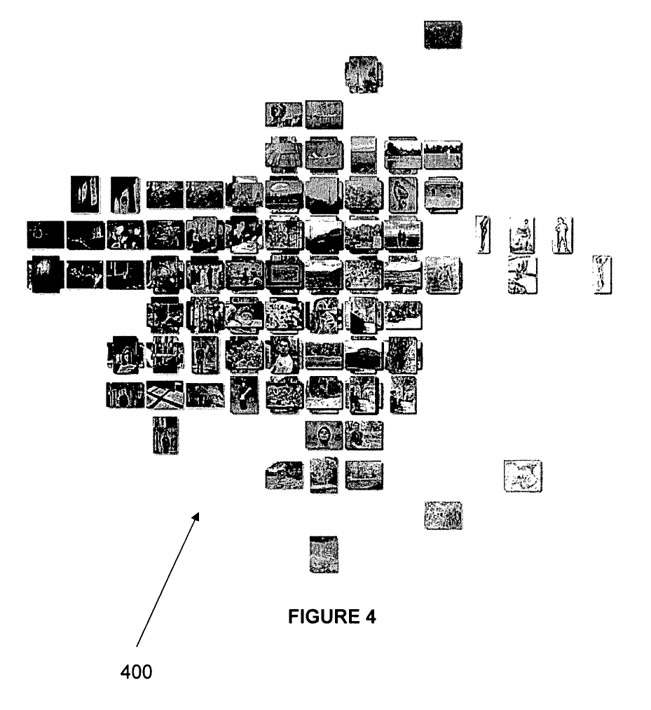

FIG. 4 is an exemplary image layout without image overlap according to one embodiment of the present invention. This example employs a gridding, overlap-resolution algorithm. In that case, images are aligned to a grid with grid elements the size of a thumbnail. Several images may occupy a single grid position but the grid format gives an appearance of order and separation amongst the grid elements. Generally, thumbnail sharing a grid are related to each other because they were all put very, very close together by the MDS operation. User interface behavior may take advantage of this layout. For example, clicking in a single grid element may select all of the images within that grid element. Images in a single grid element could act as a single unit for other functions and purposes as may be suitable for a given application.

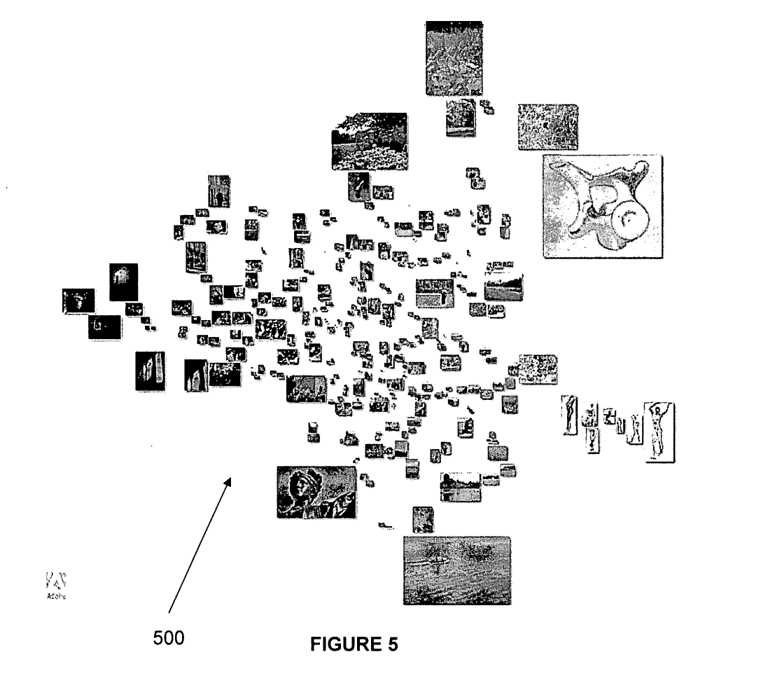

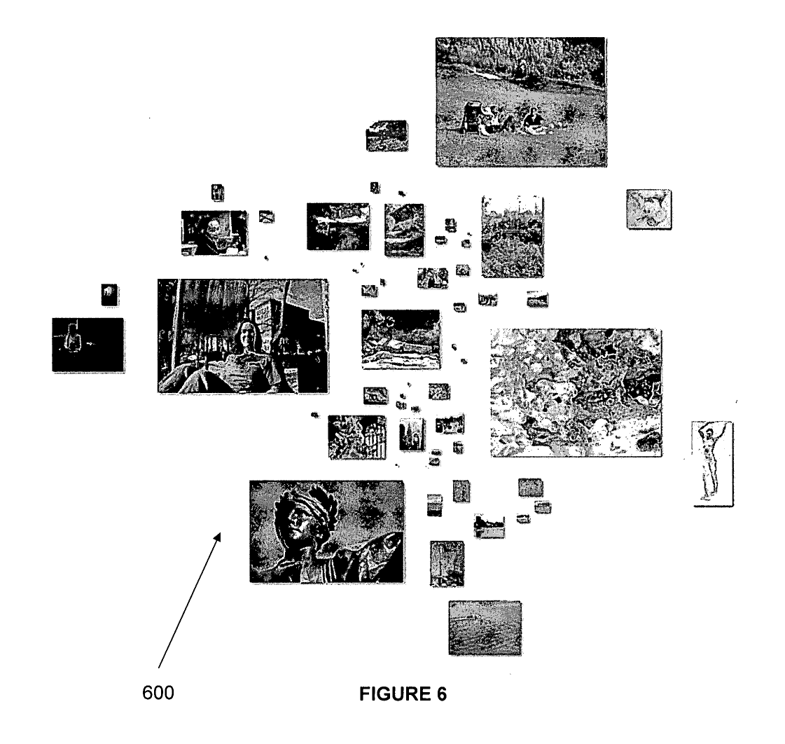

FIGS. 5 and 6 illustrate additional layouts with eliminated or reduced overlap between images. FIG. 5 illustrates the use of a simultaneous scaling overlap-resolution algorithm. Such an algorithm sets all the image sizes to a large arbitrary number and then searches for the set of scales, one per image, that when rescaled, those images will not overlap. The closer images are to other images the more scaling is likely to occur. With this type of algorithm, the center images tend to get scaled down more than those near the edges.

FIG. 6 illustrates the use of an ordered scaling overlap-resolution algorithm or fluted scaling. Such an algorithm examines one image at a time after ordering all the images in some order. It takes the first image and sets that image to be as big as possible without overlapping anyone else, but because it's the first image you can set it to a preset maximum size. And then the algorithm takes the second image in the order and scales it to the largest size that does not cause overlapping and so on. The result is a kind of a random sizing of the images in the layout, so you get to see some of them bigger sizes and some smaller.

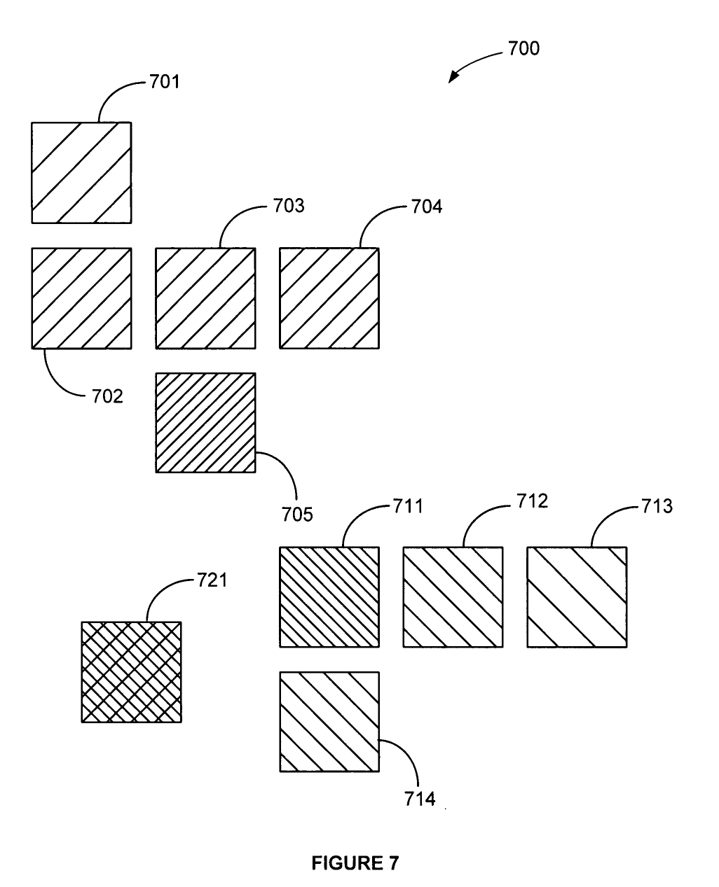

FIG. 7 illustrates another layout 700 without overlap between images produced according to one embodiment of the present invention. This example also further illustrates how images having similar content (shown as cross markings) are positioned near one another while images having less similar content are positioned generally farther from one another. As shown, image 701 is nearest images 702, 703, 704, 705 having the similar content (shown as cross marks going in the same direction) but is farther from images 711, 712, 713, 714, 721 having different content (illustrated by cross marks going the opposite direction or in both directions).

When positioned according to content (derived from tags, colors, metadata, or otherwise) images of a layout may appear grouped in ways that facilitate use. In FIG. 7, a first set of images 701, 702, 703, 704, 705 with similar content (cross marks in one direction) are roughly grouped, a second set of images 711, 712, 713, 714 with similar content (cross marks in the other direction) are roughly grouped together, and another image 721 is somewhat separated from both the first and second set of images.

As with other examples described herein, the images 701, 702, 703, 704, 705, 711, 712, 713, 714, 721 of the layout 700 of FIG. 7 are also positioned so that there is no overlap. As a specific example, certain images 701, 702, 703 have similar or identical content but do not overlap.

### General

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention. For example, in an embodiment of the invention, similarities are mixed together. As a specific example, similarities are mixed to form a tag/color similarity. Note that similarities do not require the use of tags. For example, an embodiment of the invention involves a purely color-based similarity.

1. A method of laying out images comprising:
identifying a collection of images stored on at least one electronic device, at least one tag associated with at least some of the images of the collection, wherein each of the at least one tag comprises a keyword descriptive of images associated therewith;
determining a keyword-based similarity of each image of the collection to other images of the collection using keywords of at least some of the tags associated with at least some of the images of the collection, wherein determining the keyword-based similarity of each image to other images comprises determining a frequency a first tag and a second tag are associated with a single image in the collection;
determining a layout using the keyword-based similarity between at least some of the images, the location of at least some images in the layout based at least in part on the keyword-based similarity of the image to at least one other image, and
laying out the images of the collection according to the layout.

2. The method of claim 1, wherein determining the keyword-based similarity of each image to other images comprises determining the similarity of each image to every other image of the collection.

3. The method of claim 1, wherein determining the keyword-based similarity of each image to other images comprises recognizing that two images are tagged with a same tag.

4. (canceled)

5. The method of claim 1, wherein determining the keyword-based similarity of each image to other images comprises determining the keyword-based similarity of a first image tagged with the first tag and a second image tagged with the second tag based on the frequency the first tag and second tag are associated with a single image.

6. The method of claim 1, wherein the layout is two dimensional

7. The method of claim 1, wherein the layout is one dimensional

8. The method of claim 1, wherein the layout is three dimensional.

9. The method of claim 1, wherein determining the layout comprises determining positions for the images, wherein the images of the layout reduces or eliminates overlap.

10. The method of claim 1, wherein determining the layout comprises determining positions for the images, wherein the images are of varying sizes.

11. A method of laying out images comprising:
identifying a collection of images stored on at least one electronic device at least one tag associated with at least some of the images of the collection, wherein each of the at least one tag comprises a keyword descriptive of images associated therewith;
determining a combination of keyword-based similarities amongst certain of the images of the collection, wherein at least one of the keyword-based similarities relates to similarity of keywords amongst tags associated with the images determined based at least in part on a frequency that a first tag and a second tag are associated with a single image in the collection, wherein each of the tags comprises a keyword descriptive of images associated therewith;
determining low dimensional positions for the images of the collection using the combination of keyword-based similarities;
determining a layout using the low dimensional positions; and
laying out the images of the collection according to the layout.

12-18. (canceled)

19. The method of claim 11, wherein determining low dimensional positions for the images of the collection comprises multidimensional scaling.

20. The method of claim 11, wherein determining the layout comprises determining positions for the images, wherein the images of the layout do not overlap.

21. The method of claim 11, wherein determining the layout comprises determining positions for the images, wherein the images are of varying sizes.

22. The method of claim 11, wherein determining the layout comprises scaling the images to fit on a single screen without overlapping.

23. A non-transitory computer-readable medium on which is encoded program code for laying out images, the program code comprising:
program code for identifying a collection of images stored on at least one electronic device, at least one tag associated with at least some of the images of the collection, wherein each of the at least one tag comprises a keyword descriptive of images associated therewith;
program code for determining a keyword-based similarity of each image of the collection to other images of the collection using keywords of at least some of the tags associated with at least some of the images of the collection, wherein determining the keyword-based similarity of each image to other images comprises determining a frequency a first tag and a second tag are associated with a single image in the collection;
program code for determining a layout using the keyword-based similarity between at least some of the images, the location of at least some images in the layout based at least in part on the keyword-based similarity of the image to at least one other image, and
program code for laying out the images of the collection according to the layout.

24. A non-transitory computer-readable medium on which is encoded program code for laying out images, the program code comprising:
program code for identifying a collection of images stored on at least one electronic device;
program code for determining a combination of similarities amongst certain of the images of the collection, wherein at least one of the similarities relates to similarity of keywords amongst tags associated with the images determined based at least in part on a frequency that a first tag and a second tag are associated with a single image in the collection, wherein each of the tags comprises a keyword descriptive of images associated therewith;
program code for determining low dimensional positions for the images of the collection using the combination of keyword-based similarities;
program code for determining a layout using the low dimensional positions; and
laying out the images of the collection according to the layout.
